(19) United States
(12) Patent Application Publication
(10) Pub. No.: US 2026/0154067 A1
(43) Pub. Date: Jun. 4, 2026

(54) System and Method for AI-Assisted Replacement of Software Components

(71) Applicants: Cameron Immesoete, Orinda, CA (US); Matthew Immesoete, Orinda, CA (US); Cary Immesoete, Orinda, CA (US)

(72) Inventors: Cameron Immesoete, Orinda, CA (US); Matthew Immesoete, Orinda, CA (US); Cary Immesoete, Orinda, CA (US)

(21) Appl. No.: 18/964,097

(22) Filed: Nov. 29, 2024

(51) Int. Cl. G06F 8/70; G06F 8/30

(52) U.S. Cl. CPC G06F 8/70; G06F 8/30

(57) ABSTRACT

Implementations described herein relate to methods, systems, and computer programs for dynamically replacing software components, services, or functionalities with large language models or other artificial intelligence (AI) systems. Developers can provide high-level prompts or descriptors within a software application, such as within a web application, in place of for example traditional backend code or components. An AI model interprets these prompts and either directly performs the desired functionalities or generates and maintains code or scripts that implement them. This approach enables the application to function as intended without for example the developer needing to write the backend code, and it can be extended to various application types, including web applications, image processing software, video games, and more.

### TECHNICAL FIELD

Embodiments relate generally to software development, artificial intelligence, and dynamic code generation, and more particularly, to methods, systems, and computer-readable media for replacing traditional software components with AI models that interpret prompts and generate or execute code to fulfill specific functionalities.

### BACKGROUND

Traditional software development often requires developers to write frontend code, backend code, and more, involving significant effort and expertise in various programming languages and systems. For example, creating a web application typically entails designing the user interface and implementing backend microservices to handle functionalities like user interactions, data processing, and database management. This process can be time-consuming and demands proficiency in multiple domains.

The emergence of large language models and AI presents an opportunity to streamline the development process. By using AI to interpret high-level prompts or descriptions, developers can generate, for example, the necessary backend code or have the AI directly execute the functionalities. This innovation reduces the development effort and lowers the barrier to creating complex software applications.

### SUMMARY

According to an aspect, a computer-implemented method for dynamically replacing software components with AI models or communication therewith is provided. The method includes:
Receiving prompts or descriptors within a software application in place of traditional code for certain components or services.
Utilizing an AI model, such as a large language model, to interpret the prompts and other inputs and either:
   1. Directly execute the desired functionalities, such as handling user interactions, data storage, and processing.
   2. Generate and maintain code or scripts that implement the functionalities, integrating them into the software application.
Maintaining the execution or generated code perpetually, allowing the software application to function as intended without additional backend development.

This approach can be applied to various types of applications, including but not limited to web applications, image processing software, video games, and other software requiring modular components or services.

### BRIEF DESCRIPTION OF THE DRAWINGS

FIG. 1 is a system architecture diagram illustrating the main components of an example system and their interactions. The components include a Software Application, an AI model, Generated Code/Scripts, and Data Storage.

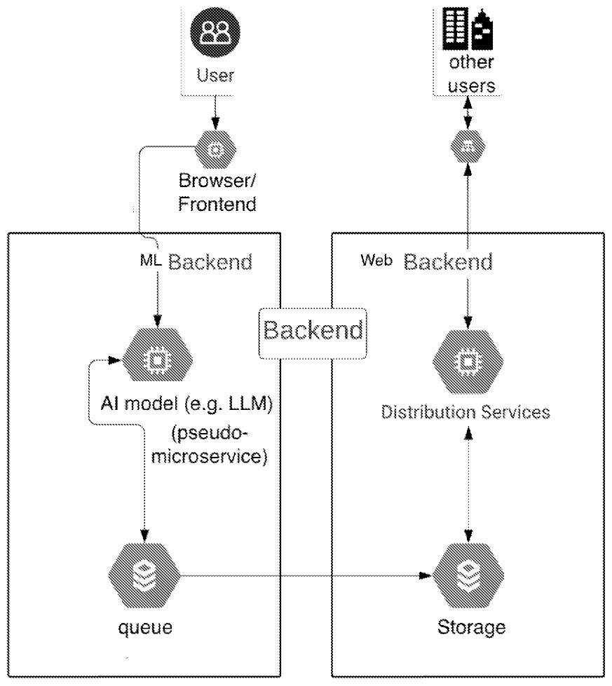

1. A computer-implemented method for dynamically replacing software components with artificial intelligence models, the method comprising:
a. receiving, within a software application, one or more prompts or descriptors representing functionalities or services to be performed;
b. utilizing an artificial intelligence model to interpret the one or more prompts or descriptors;
c. based on the interpretation, performing at least one of:
i. directly executing the functionalities or services represented by the prompts or descriptors; and
ii. generating code or scripts that implement the functionalities or services, and integrating the generated code or scripts into the software application;
d. wherein the artificial intelligence model maintains the execution or generated code over time, allowing the software application to function as intended without the developer writing traditional code for the replaced components.

2. The method of claim 1, wherein the software application is a web application, and the prompts or descriptors are included in the frontend code to represent backend microservice functionalities.

3. The method of claim 1, wherein the artificial intelligence model is a large language model trained on software code and documentation to facilitate accurate interpretation and code generation.

4. The method of claim 1, further comprising updating the generated code or scripts based on changes in the prompts or descriptors, allows dynamic modification of the software application's functionalities.

5. The method of claim 1, wherein the method is applied to software components in applications such as image processing software or video games, replacing traditional functions with AI-interpreted prompts.

6. The method of claim 1, wherein the artificial intelligence model interacts with a database to store and retrieve data as part of executing the functionalities represented by the prompts or descriptors.
